(19) United States
(12) Patent Application Publication
(10) Pub. No.: US 2022/0301064 A1
(43) Pub. Date: Sep. 22, 2022

(54) SYSTEMS AND METHODS FOR ELECTRONICALLY GENERATING AND MANAGING EXCHANGE-TRADED NOTES FOR INSURANCE

(71) Applicant: BlueOwl, LLC, San Francisco, CA (US)

(72) Inventor: Michael Sungjun Kim, Fairfax, VA (US)

(21) Appl. No.: 16/885,342

(22) Filed: May 28, 2020

(51) Int. Cl. G06Q 40/08; G06Q 40/04; H04L 9/06

(52) U.S. Cl. CPC G06Q 40/08; G06Q 40/04; H04L 9/0637; H04L 2209/38

(57) ABSTRACT

An exchange-traded note (ETN) having a plurality of ETN shares is generated and issued. Each ETN share of the ETN is issued having an initial share price. Buy orders are received to buy one or more ETN shares. The ETN tracks a plurality of internal and external indexes. The ETN share price fluctuates in accordance with the performance of the indexes. Data of the ETN is stored on a memory device and implemented as part of a blockchain architecture. Stored ETN data are updated periodically in response to a change of the plurality of internal and external indexes. An insurance premium cost is based at least in part upon the ETN share price.

### FIELD OF THE DISCLOSURE

The present disclosure relates to systems and methods for exchange-traded notes, and more particularly, to systems and methods for determining insurance premium costs based at least in part upon exchange-traded note prices.

### BACKGROUND

Exchange-traded notes, or ETNs, are a type of unsecured, unsubordinated debt security. Typically, ETNs are based at least in part upon the performance of a market index, minus applicable fees, with no period coupon payments and no principal protections. Further, ETNs do not show ownership in a pool of securities. ETNs have a maturity date and are backed by the credit of the issuer, or by the underwriting bank that issued the ETN. When an ETN matures, the issuer subtracts their fees and then pays out, in cash, to the original investor based at least in part upon the performance of the underlying index of the ETN.

Vehicle insurance premium pricing typically depends on publicly available information, such as weather, the stock market, inflation, etc. Other factors may also affect vehicle insurance premium pricing, such as an individual's driving record, how much the car to be insured is driven, as well as the location of where the insured individual resides (e.g., urban, suburban, or rural). The calculation of an individual's insurance premium is based at least in part upon a wide range of factors and is often a highly complex calculation.

Vehicle insurance provides financial protection against physical damage or bodily injury caused by a vehicular accident. Other financial protections may be provided, such as protection against vehicle theft or damage caused by natural disasters. Conventionally, car insurance rates, or premiums, are typically determined based at least in part upon a driver's age and driving history, car make, model, and year, among a myriad of other factors.

Some vehicle insurance companies provide premium discounts to drivers that exhibit safe driving characteristics. Discounts are typically calculated based at least in part upon annual mileage and basic driving characteristics, such as braking, speed, time of day travel, acceleration rates, and fast cornering. Vehicles may be equipped with navigation systems capable of tracking driving characteristics. For example, a mobile device can be carried by a driver during vehicle operation that would automatically track the driver's behavior. Tracking is typically done via one or more integrated sensors or other devices, such as geo-spatial positioning modules, accelerometers, gyroscopes, or the like. A GPS module typically provides location information, for example latitude-longitude coordinates, which can then be used to pinpoint an exact location of a driver. Other devices, such as accelerometers and gyroscopes, provide measurements of acceleration of a sensor as well as an orientation, or direction, of the device.

At least some applications may benefit from using exchange-traded notes (ETNs) for insurance premium pricing purposes. In such applications, ETNs may be utilized to track and determine relevant external and internal indexes with respect to insurance claims data in view of select demographics. Risk analysis may then be reflected by the ETNs, and insurance premium pricing may be set appropriately.

### BRIEF SUMMARY

The present embodiments may relate to, inter alia, systems and methods for the tracking and leveraging of a plurality of indexes to create an exchange-traded note based at least in part upon the performance of the plurality of indexes. In some embodiments, the systems and methods described herein may also include systematic extraction of data and information to generate one or more exchange-traded notes based at least in part upon the performance of a plurality of indexes to determine accurate pricing of insurance premiums, such as automobile insurance premiums. In one example of embodiment, the process may be performed by an exchange-traded note tracking (ETNT) computing device.

In one aspect, an exchange-traded note (ETN) computing device having at least one processor in communication with a memory device is provided. The at least one processor may be configured to: (1) generate, by the ETN computing device, at least one ETN having a plurality of ETN shares, (2) issue, by the ETN computing device, the plurality of ETN shares, each ETN share having an initial share price, (3) receive, from at least one investor computing device, buy orders to buy one or more of the plurality of ETN sharesETN shares, (4) track, by the ETN computing device, a plurality of indexes, wherein index data associated with the plurality of indexes is obtained from one or more index computing devices (5) determine, by the ETN computing device, a change in the ETN share price shares based at least in part upon the index data, (6) store ETN data associated with the at least one ETN on the memory device, wherein the memory device is part of an implemented blockchain architecture, (7) determine an insurance premium cost based at least in part upon the ETN share price, and (8) update the stored ETN data in response to a change of one or more of the plurality of indexes. The computing device may include additional, less, or alternate actions, including those discussed elsewhere herein.

In another aspect, a computer-based method for calculating an insurance premium by a computing device including one processor in communication with a memory device is provided. The computer-based method may include (1) generating at least one ETN having a plurality of ETN shares, (2) issuing the plurality of ETN shares, each ETN share having an initial share price, (3) receiving buy orders to buy one or more of the plurality of ETN sharesETN shares, (4) tracking a plurality of indexes, wherein index data associated with the plurality of indexes is obtained from one or more index computing devices, (5) determining a change in the ETN share price shares based at least in part upon the index data, (6) storing ETN data associated with the at least one ETN on the memory device, wherein the memory device is part of an implemented blockchain architecture, (7) determining an insurance premium cost based at least in part upon the ETN share price, and (8) updating the stored ETN data in response to a change of one or more of the plurality of indexes. The computer-based method may include additional, less, or alternate actions, including those discussed elsewhere herein.

In yet another aspect, at least one non-transitory computer-readable storage media having computer-executable instructions embodied thereon may be provided that, when executed by at least one processor, the computer-executable instructions cause the processor to: (1) generate at least one ETN having a plurality of ETN shares, (2) issue the plurality of ETN shares, each ETN share having an initial share price, (3) receive buy orders to buy one or more of the plurality of ETN sharesETN shares, (4) track a plurality of indexes, wherein index data associated with the plurality of indexes is obtained from one or more index computing devices, (5) determine a change in the ETN share price shares based at least in part upon the index data, (6) store ETN data associated with the at least one ETN on the memory device, wherein the memory device is part of an implemented blockchain architecture, (7) determine an insurance premium cost based at least in part upon the ETN share price, and (8) update the stored ETN data in response to a change of one or more of the plurality of indexes. The computer-executable instructions may include additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an example of exchange-traded notes tracking (ETNT) system in accordance with an example of embodiment of the present disclosure.

FIG. 2 depicts an example of client computing device that may be used with the ETNT system illustrated in FIG. 1.

FIG. 3 depicts an example of server system that may be used with the ETNT system illustrated in FIG. 1.

FIG. 4 depicts an example of block diagram illustrating an ETN exchange in accordance with one or more embodiments of the present disclosure.

FIG. 5 depicts an example of process diagram 500 for determining a price of a driver's insurance premium based at least in part upon one or more tracked ETNs using the ETNT system illustrated in FIG. 1.

The Figures depict preferred embodiments for purposes of illustration only. One skilled in the art will readily recognize from the following discussion that alternative embodiments of the systems and methods illustrated herein may be employed without departing from the principles of the present invention.

### DETAILED DESCRIPTION OF THE DRAWINGS

The present embodiments may relate to, inter alia, systems and methods for the tracking and leveraging of a plurality of indexes to create a plurality of exchange-traded notes (ETN) based at least in part upon the performance of the plurality of indexes, including external and internal indexes. In some embodiments, the systems and methods described herein may also include systematic extraction of data and information to create one or more exchange-traded notes based at least in part upon the performance of a plurality of indexes to determine accurate pricing of insurance premiums, such as automobile insurance premiums. In some embodiments, a premium price may be set in view of determined share prices of one or more of the plurality of ETNs. Additionally, one or more of the plurality of ETNs may be implemented as a smart contract between entities. The smart contract may be created within a cryptocurrency ecosystem, such as an Ethereum® token, or the like. In one example of embodiment, the process may be performed by an exchange-traded note tracking (ETNT) computing device.

In some embodiments, the systems and methods may be used to implement an ETN-based insurance premium pricing platform. In an ETN-based insurance premium pricing platform, an insurance premium may correspond to a share price of an ETN. For example, the insurance premium may be based, at least in part, on the performance of one or more underlying indexes tracked by an ETN wherein the performance is reflected by the ETN share price. Underlying indexes may include one or more of internal indexes, external indexes, or a combination thereof. An external index may include any type of index data available to the public, or published information. An example external index may include stock market pricing information, weather data, or the like. An internal index may include any type of index data that is not generally made available to the public (e.g., private information). Example internal data may include insurance claims data, personal or private demographic data, or the like. It may thus be advantageous to select one or more indexes that would most accurately represent an accurate model for the pricing of an insurance premium, such as an insurance premium for a typical driver.

In some embodiments, the systems and methods described herein may additionally or alternatively include the providing of one or more ETNs for trade on an exchange. The one or more ETNs may be created to track an underlying index. In some embodiments, the underlying index may be an external index, such as the weather, the U.S. stock market, inflation rates, department of transportation (DOT) data, or a combination thereof. Other like indexes may be tracked by one or more ETNs. A share price of the one or more ETNs may fluctuate, much like shares of a stock on a stock exchange, based at least in part upon data of the underlying index or indexes with respect to the performance of the one or more indexes. In some embodiments, an entity, such as an investor, may be enabled to buy shares via buy orders of an ETN, such as via an exchange enabled to facilitate the trading of one or more ETNs.

Examples of Creating an Exchange-Traded Note

An ETNT computing device may establish an ETN for tracking one or more underlying indexes. As described below, systems and methods described herein include the tracking of a plurality of indexes including one or more internal indexes and one or more external indexes. The one or more internal and one or more external indexes may be considered underlying indexes and may be tracked by a series of investment vehicles. In one example, the investment vehicle may be an Exchange-Traded Note, or ETN, and may be created to track one or more indexes. An actual index value may be determined based at least in part upon prices of holdings within a certain underlying index. In another non-limiting example, an index may include department of transportation, or DOT, traffic data, such as accident statistics or other types of traffic-related data. In one non-limiting example, an index may include all stocks traded on a certain stock exchange. The ETN may then track each and every stock within the stock exchange. Based at least in part upon the collective performance of each and every stock, the value of the ETN may fluctuate accordingly. Quite simply, as the price values increase for each and every stock, so will the value of the ETN. On the other hand, as the price values decrease for each and every stock, so will the value of the ETN. Taken in combination, an ETN may be created to include the stock index and the DOT index and may take into account both an indication of the health of an economy as well as the occurrence of driving mishaps.

An external index may provide an indicator of the performance of one or more public indexes, such as a stock market, inflation, weather data, traffic data, or the like. As described above, the external index may provide cost fluctuations of certain stock shares included within a certain grouping of stocks. For example, the group of stocks may include a total stock market index, an S&P 500 index, or so-called large cap stocks. It is understood that the external index discussed herein is not limited to any certain type of stock market index. For example, other indexes may be tracked, such as the prices of certain commodities (e.g., coal, gas, gold, etc.). Another external index, such as a weather data index, may be used to accurately predict certain weather conditions, such as unusual or expected weather patterns, for example.

An internal index may provide an indicator of certain private indexes, such as claims data of certain drivers. Additionally, or alternatively, the private index may track claims data of drivers belonging to key demographics, of drivers residing within a certain region or state, or a combination thereof. Such a private index may provide one or more indicators of potential risk. The potential risk may fluctuate as well, based at least in part upon changes in weather, new traffic patterns, or even the implementation of safer driving methodologies.

In some embodiments, an ETN may be created in view of one or more tracked indexes. The tracked indexes may include one or more internal indexes, external indexes, or a combination of both internal and external indexes. A price of each ETN share of an ETN may then be calculated based at least in part upon the performance of the underlying index or indexes. Based at least in part upon the performance of the underlying index or indexes, the price of the share may fluctuate over time.

Examples of Implementing an ETN Via a Crypto Network

The ETNT computing device may employ the use of a blockchain network to conduct transactions, establish smart contracts, or even perform trading of certain properties. In some embodiments, an ETN may be implemented on a cryptocurrency network via one or more smart contracts. For example, an ETN may be implemented on the Ethereum® network (Ethereum® is a registered trademark of the Ethereum Foundation) as a smart contract. A smart contract via a cryptocurrency token may enable the tracking of ownership of the ETN, as well as performing dividend payouts, as outlined by the smart contract. For example, an issuer of the ETN may specify certain actions to occur based at least in part upon the performance of one or more underlying indexes associated with the ETN. In some embodiments, an issuer may indicate a cash payout, or dividend payout, if one or more of the underlying indexes of the ETN reach or surpass predetermined threshold levels.

In some embodiments, a blockchain network may enable the secure implementation of one or more ETNs in performing not just the tracking of certain underlying indexes, but also the secure tracking of private indexes. As described below, private indexes may include personal information of certain individuals. Leveraging a secure blockchain framework, such as the Ethereum® blockchain, or the like, may enable the secure data processing needed for implementation of the disclosed.

Examples of Determining ETN Value

In some embodiments, an ETN may be guaranteed by a certain institution, such as a financial institution or a bank. The value of an ETN may be directly related towards the one or more underlying indexes and does not actually represent any assets, such as stocks or commodities. The value of the ETN may be directly influenced by the value of the underlying index. For example, if the underlying index is the S&P 500, the ETN value may fluctuate based at least in part upon the performance of the S&P 500. Additionally or alternatively, the return of the ETN may be calculated based at least in part upon a benchmark of the one or more underlying indexes.

An ETN value, or price, may be determined based at least in part upon the performance of the underlying plurality of indexes. Performance may be affected by fluctuations of both public and private data indexes. Certain thresholds may be created based at least in part upon private data indexes, such as indexes based at least in part upon claims data of a certain individual. Additionally, or alternatively, private data indexes may include private data of a certain key demographic or a group of users residing within a certain region or state. In some embodiments, thresholds may be set with respect to a certain number of insurance claims made by an individual.

Examples of Determining an Insurance Premium Based at Least in Part Upon ETN

Further, in some embodiments, an insurance premium price may be determined based at least in part upon one or more ETNs. For example, an insurance premium may be determined for different types of insurance carriers, such as home, automobile, life, or the like. As described above, an ETN may be created to track one or more of a series of underlying indexes, including one or more internal and external indexes. In some embodiments, an insurance carrier may leverage a price fluctuation of an ETN to ultimately determine and calculate a price of an insurance premium. In some embodiments, the insurance premium may adjust dynamically over time based at least in part upon a performance of the ETN, which is directly influenced by the one or more of the series of the underlying indexes. Additionally or alternatively, insurance premium rates may also be influenced by other factors in addition to the ETN data, such as demographics data, claims data, regional data, or the like with respect to a certain individual to be insured.

Examples of System for Exchange-Trade Note Tracking

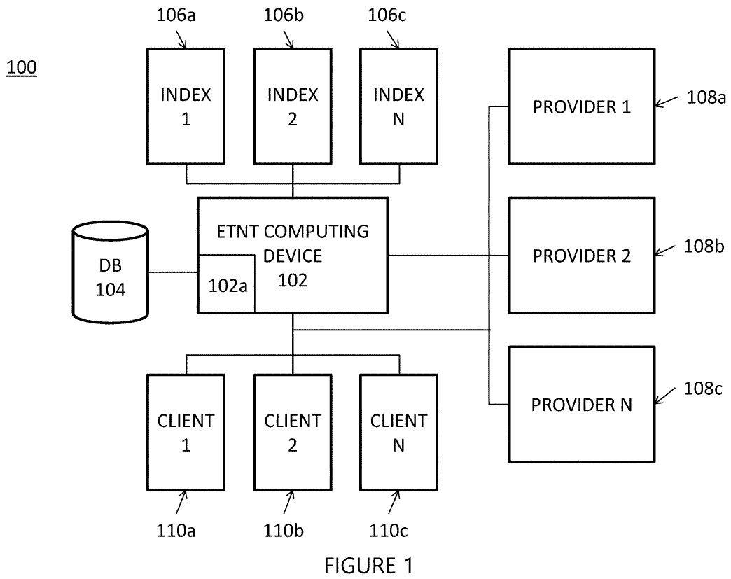

FIG. 1 depicts an example of Exchange-Trade Note Tracking (ETNT) system 100. ETNT system 100 may include an ETNT computing device 102. ETNT computing device 102 may include a database server 102a and may be in communication with, for example, a database 104, one or more index devices 106a, 106b, and 106c, one or more provider devices 108a, 108b, and 108c, and one or more user devices 110a, 110b, and 110c. User devices 110a, 110b, and 110c may be, for example, mobile devices, tablet PCs, portable computers, or the like. In some embodiments, ETNT computing device 102 may be associated with, for example, an insurer providing an adjustable insurance policy to individuals associated with user devices 110a, 110b, and 110c.

ETNT computing device 102 may receive user demographic data, regional data, location information, and/or telematics data from one or more user devices 110a, 110b, and 110c. A typical user device, or client device, may include components for capturing and generating data, such as a GPS device, an accelerometer, a gyroscope, and/or any other device capable of capturing data. ETNT computing device 102 may use the received geographic coordinate data and telematics data to develop a driver profile for the one or more users of the user devices. User driver profiles may be stored on database 104, for example. Database 104 may be implemented as a local storage option. Alternatively, database 104 may be a remote storage location, such as a cloud storage option.

User devices 110a, 110b, and 110c may be equipped with, for example, a GPS device. A GPS device may utilize GPS techniques to determine a measurement of geographic coordinates of the corresponding user device. Because some factors (e.g., atmospheric effects) may reduce the precision of a GPS device, the GPS device may return, for example, an error estimate along with the measured geographic location. The measured geographic location and error estimate may provide an area (e.g., a radius around the measured geographic location) where the corresponding user device may be located with an associated probability.

User devices 110a, 110b, and 110c may also be equipped with, for example, an accelerometer and/or a gyroscope. An accelerometer may be capable of measuring a linear and/or angular acceleration of the corresponding user device at a given moment in time. A gyroscope may be capable of determining an orientation of the user device. Accordingly, an accelerometer and a gyroscope together may be used to determine a direction of acceleration of the user device. Data generated by an accelerometer and a gyroscope may be used (e.g., by ETNT computing device 102 or one of user devices 110a, 110b, and 110c) to generate telematics data (e.g., a location, orientation, acceleration, velocity, etc.) of the corresponding user device. Such telematics data may be used by ETNT computing device 102, for example, to generate a driving profile of a user including certain data, such as driver location (e.g., municipality, state) and driver habits (e.g., hard/soft braking, speed over/under speed limit, slow/sharp cornering).

In some embodiments, ETNT computing device 102 may verify the identification of the driver. For example, ETNT computing device 102 may transmit a verification message to one of user devices 110a, 110b, and 110c via a text message and/or via a mobile application (app) running on one of user devices 110a, 110b, and 110c. The message may include an indication that one of user devices 110a, 110b, and 110c has been identified as corresponding to the driver of a vehicle. If the user responds in the affirmative, ETNT computing device 102 may proceed with the collection of data with respect to driver behavior characteristics.

In some embodiments, ETNT computing device 102 may receive user demographics data. For example, ETNT computing device 102 may collect user demographics data from one or more of user devices 110a, 110b, and 110c via email or via a mobile application running on one of user devices 110a, 110b, and 110c. A user may be prompted to respond to a series of questions for self-identification purposes. Questions may include, but are not limited to, age, income source, occupation, income level, ethnicity, race, gender, or the like. User responses may be compiled and saved as part of a user's profile.

In some embodiments, ETNT computing device 102 may receive claims data from one or more of user devices 110a, 110b, and 110c. For example, after a user has made an insurance claim, the details of the insurance claim may be transmitted via a portal of the ETNT computing device 102, such as a mobile application or desktop web application. Claims data may include location of accident, nature of accident, fault data, cost of repairs, etc. Such information may be collected and stored in a database, such as database 104, by ETNT computing device 102. Collected data may be indexed and analyzed in view of other data collected of system users, such as demographics data and driving behavior data as disclosed herein. In some embodiments, the collected claims data, demographics data, and driver behavior data may be considered internal index data.

In additional embodiments, ETNT computing device 102 may receive index data, or external index data, from index computing devices, or servers, 106a, 106b, and 106c. Index devices 106a, 106b, and 106c may include certain external index data including, but not limited to, the S&P 500 market index, traffic data (e.g., DOT data), or even weather data indexes. Such external data indexes may be collected individually by ETNT computing device 102 and analyzed to provide an overall index, or collective index. In some embodiments, collected index data from index devices 106a, 106b, and 106c may be compared or taken in combination with one or more internal indexes (e.g., claims data, demographic data). In some embodiments, ETNT computing device 102 may be configured to create an exchange-traded note (ETN) based at least in part upon one index or a collection of indexes acting as underlying indexes.

In some embodiments, ETNT computing device 102 may be used to implement an ETN-based insurance platform. ETNT computing device 102 may be in communication with one or more provider devices 108a, 108b, and 108c. In an ETN-based insurance policy, an insurance premium may correspond to a price of an exchange-trade note. Alternatively, an insurance premium may correspond to the prices of multiple exchange-traded notes associated with a plurality of different underlying indexes. In some embodiments, a price of an ETN may reflect an associated risk. For example, a demographic ETN may reflect a risk associated with a key demographic. In one non-limiting example, an ETN price associated with a demographic of teen drivers may be higher than an ETN price associated with a demographic of middle-aged drivers. For example, the insurance premium may be based, at least in part, on the performance of one or more underlying indexes tracked by an ETN. By selecting one or more key underlying indexes, ETNT computing device 102 creates an accurate model for the pricing of an insurance premium for a typical driver. ETN-based insurance may be offered to any one of the users of client devices 110a, 110b, and 110c.

Examples of Client Computing Device

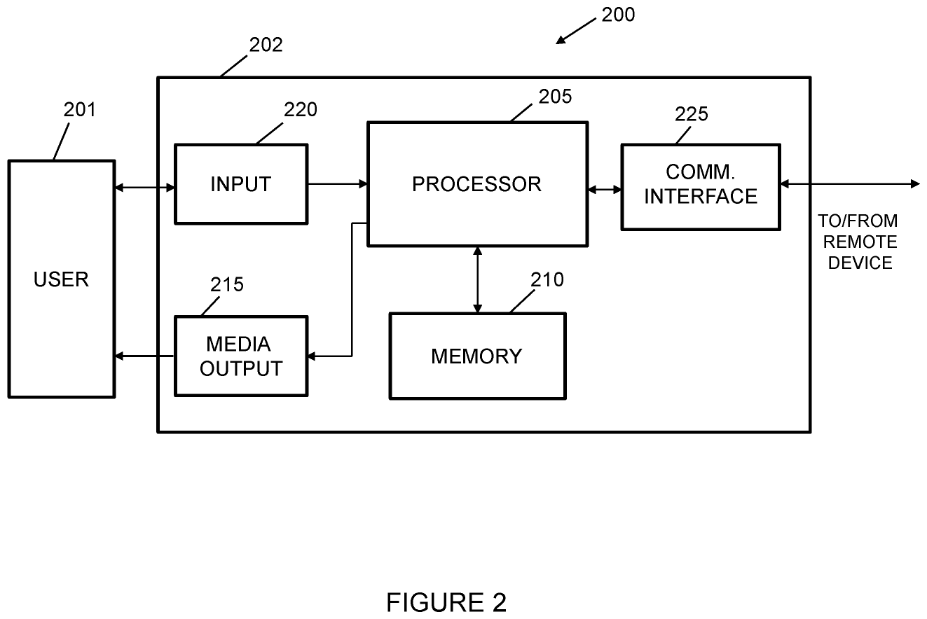

FIG. 2 depicts a block diagram 200 of an example of client computing device 202 that may be used with the exchange-traded note tracking (ETNT) computing system 100 shown in FIG. 1. Client computing device 202 may be, for example, at least one of ETNT computing device 102, user devices 110a-c, index devices 106a-c, or provider devices 108a, 108b, and 108c (all shown in FIG. 1).

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In one or more embodiments, computing device 202 may also include one media output component 215 for presenting information a user 201. Media output component 215 may be any component capable of conveying information to user 201. In some embodiments, media output component 15 may include an output adapter such as a video adapter and/or an audio adapter. An output adapter may be operatively coupled to processor 205 and operatively coupled to an output device such as a display device (e.g., a liquid crystal display (LCD), a light emitting diode (LED) display, an organic light emitting diode (OLED) display, a cathode ray tube (CRT) display, an “electronic ink” display, a projected display, etc.) or an audio output device (e.g., a speaker arrangement or headphones). Client computing device 202 may also include an input device 220 for receiving input from a user 201. Input device 220 may include, for example, a keyboard, a pointing device, a mouse, a stylus, a touch sensitive panel (e.g., a touch pad or a touch screen), a gyroscope (e.g., gyroscope 114a or gyroscope 114b), an accelerometer (e.g., accelerometer 112a or accelerometer 112b), a position detector (e.g., GPS 110a or GPS 11b), or an audio input device. A single component, such as a touch screen, may function as both an output device of media output component 215 and an input device of input device 220.

Client computing device 202 may also include a communication interface 225, which can be communicatively coupled to a remote device, such as CSP computing device 102 of FIG. 1. Communication interface 225 may include, for example, a wired or wireless network adapter or a wireless data transceiver for use with a mobile phone network (e.g., Global System for Mobile communications (GSM), 3G, 4G, or Bluetooth) or other mobile data networks (e.g., Worldwide Interoperability for Microwave Access (WIMAX)). The systems and methods disclosed herein are not limited to any certain type of short-range or long-range networks.

Stored in memory area 210 may be, for example, computer readable instructions for providing a user interface to user 201 via media output component 215 and, in certain examples, receiving and processing input from input device 220. A user interface may include, among other possibilities, a web browser or a client application. Web browsers may enable users, such as user 201, to display and interact with media and other information typically embedded on a web page or a website.

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAN). The above memory types are examples only, and are thus not limiting as to the types of memory usable for storage of a computer program.

In some embodiments, processor 205 may include and/or be communicatively coupled to one or more modules for implementing the systems and methods described herein.

In some embodiments, client computing device 202 may also include one media output component 215 for presenting information to a user 201. Media output component 215 may be any component capable of conveying information to user 201. In some embodiments, media output component 215 may include an output adapter such as a video adapter and/or an audio adapter. An output adapter may be operatively coupled to processor 205 and operatively couplable to an output device such as a display device (e.g., a liquid crystal display (LCD), light emitting diode (LED) display, organic light emitting diode (OLED) display, cathode ray tube (CRT) display, “electronic ink” display, or a projected display) or an audio output device (e.g., a speaker or headphones). Media output component 215 may be configured to, for example, display an alert message identifying a statement as potentially false.

Client computing device 202 may also include an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

Client computing device 202 may also include a communication interface 225, which can be communicatively coupled to a remote device such as ETNT computing device 102 (shown in FIG. 1). Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 210 may be, for example, computer-readable instructions for providing a user interface to user 201 via media output component 215 and, in certain examples, receiving and processing input from input device 220. A user interface may include, among other possibilities, a web browser and client application. Web browsers may enable users, such as user 201, to display and interact with media and other information typically embedded on a web page or a website.

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

Examples of Server System

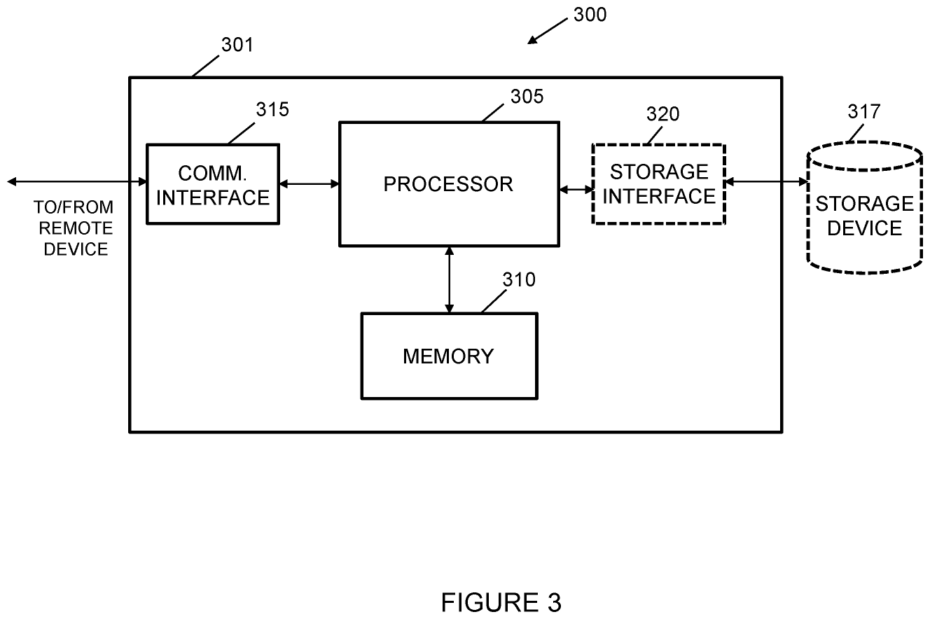

FIG. 3 depicts a block diagram 300 showing an example of server system 301 that may be used with ETNT computing system 100 illustrated in FIG. 1. Server system 301 may be, for example, server computing device 102a (shown in FIG. 1).

In some embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be needed in order to perform one or more processes described herein, while other operations may be more general and/or specific to a particular programming language (e.g., C, C#, C++, Java, or other suitable programming languages, etc.).

Processor 305 may be operatively coupled to a communication interface 315 such that server system 301 is capable of communicating with ETNT computing device 102, client devices 110a, 110b, and 110c, index devices 106a, 106b, and 106c, and provider devices 108a, 108b, and 108c (all shown in FIG. 1), and/or another server system. For example, communication interface 315 may receive data from one or more client devices 110a, 110b, and 110c via the Internet.

Processor 305 may also be operatively coupled to a storage device 317, such as database 106 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317. In other embodiments, storage device 317 may be external to server system 301 and may be accessed by a plurality of server systems. For example, storage device 317 may include multiple storage units such as hard disks or solid state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer system.

In some embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be needed in order to perform one or more processes described herein, while other operations may be more general and/or specific to a particular programming language (e.g., C, C#, C++, Java, or other suitable programming languages, etc.).

Processor 305 may be operatively coupled to a communication interface 315 such that server system 301 is capable of communicating with DI computing device 102, first user device 110, second user device 112 (all shown in FIG. 1), and/or another server system 301. For example, communication interface 315 may receive data from one or more client user devices 110a, 110b, and 110c via the Internet.

Processor 305 may also be operatively coupled to a storage device 317, such as database 120 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317. In other embodiments, storage device 317 may be external to server system 301 and may be accessed by a plurality of server systems 301. For example, storage device 317 may include multiple storage units such as hard disks or solid state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

Example ETN Exchange System

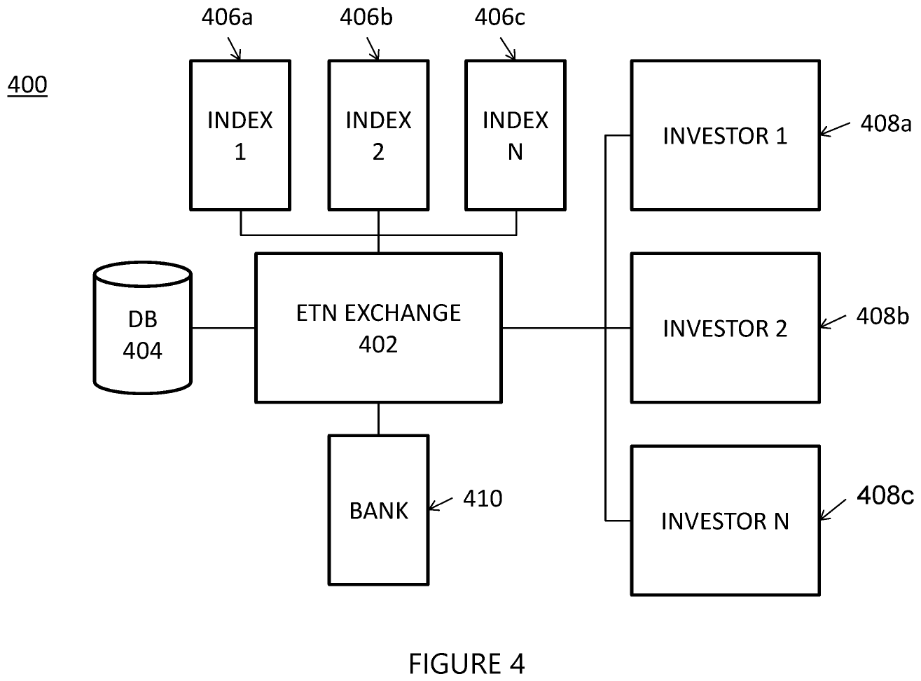

FIG. 4 depicts a block diagram 400 for an example of ETN exchange implementation in accordance with one or more embodiments disclosed herein. The implementation may include one ETN exchange server 402 configured to provide an exchange for one or more investors to submit buy order to purchase ETNs based at least in part upon an advertised share price. The ETN share price may fluctuate based at least in part upon the performance of w of one or more underlying indexes. In some embodiments, investors may communicate with ETN exchange server 402 via one or more user devices 408a, 408b, and 408c. Further, the one or more underlying indexes may be tracked by ETN exchange server 402 via one or more index devices 406a, 406b, and 406c. One or more of the ETNs provided on the ETN exchange server 402 may be underwritten by one or more banks or financial institutions, represented by a bank device 410. Data pertaining to one of the ETNs may be stored on a memory device, such as a database 404. In another embodiment, data pertaining to one or more of the ETNs provided by ETN exchange server 402 may be stored on a decentralized network, such as a blockchain network.

In some embodiments, underlying index devices 406a, 406b, and 406c, may represent or track a plurality of different indexes. Example external indexes may include department of traffic (DOT) data, market data (e.g., S&P 500, total stock market, commodities), weather data, or the like.

In some embodiments, implementation of ETN exchange server 402 and tracking of one or more ETNs may be performed via a blockchain network, such as an Ethereum® blockchain. All transactions conducted by ETN exchange server 402, such as trades and the updating of ETN price due to fluctuation may be performed by the designated blockchain network. In the given example, the Ethereum® network may include a plurality of nodes to confirm transactions to be performed and implement decentralized trust.

In at least one embodiment, bank device 410 may be utilized for the underwriting of one or more of the ETNs provided via ETN exchange server 402. For simplicity, a single bank device 410 is shown, however it is understood that a plurality of financial institutions may provide needed support with respect to the buying and selling of ETNs, such as clearinghouse services. Further, the financial institution may provide a payout to the appropriate investor once an ETN matures, minus any service fees. In some embodiments, the financial institution may pay out dividends to one or more investors in response to an agreed upon dividend payout calendar, a special dividend in response to performance of the ETN, or the like. Such payouts may be agreed upon in a smart contract within a blockchain implementation.

Examples of Determining Insurance Price Based at Least in Part Upon ETN Performance

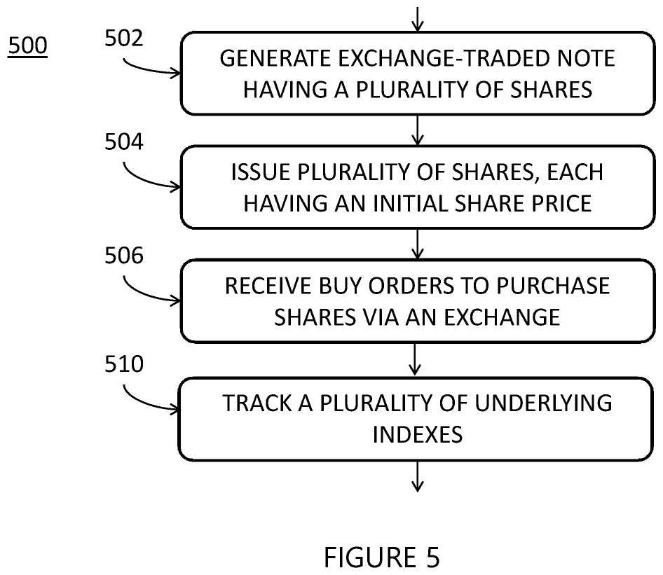

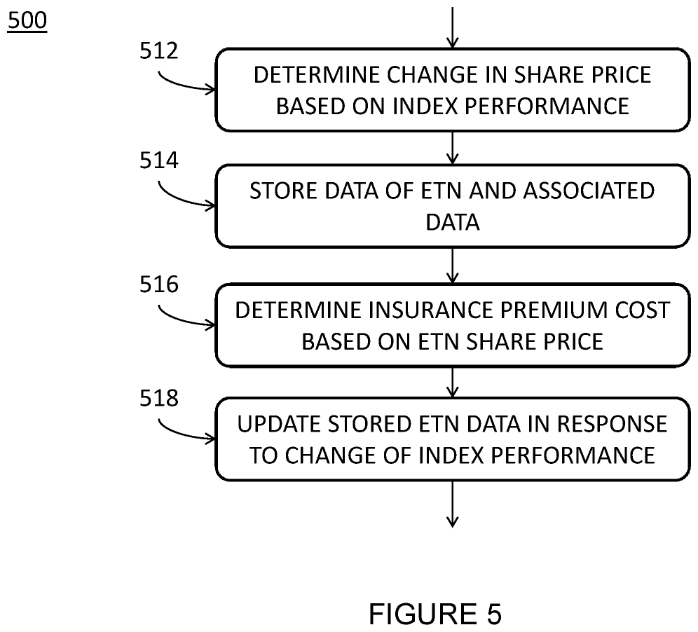

FIG. 5 depicts an example of method 500 that may include a process for determining an insurance premium cost based at least in part upon the performance of one or more ETNs. Method 500 may be implemented by ETNT computing device 102 and respective devices of FIG. 1. In some embodiments, individual users may purchase and trade shares. Alternatively, or additionally, institutional investors may purchase and trade shares on an ETN exchange, such as ETN server 402 shown in FIG. 4, by way of buy orders.

Method 500 may include the creating and generating 502 of an exchange-traded note, or ETN. An ETN may include a plurality of ETN shares. The plurality of ETN shares may issue 504 for purchase, such as via an exchange. Method 500 may include receiving 506 buy orders to purchase ETN shares via an exchange.

Method 500 may further include tracking 510 a plurality of underlying indexes. The underlying indexes may comprise of internal indexes, external indexes, or a combination thereof. The indexes may be created based at least in part upon user-submitted information, such as via an insurance provider. Over time, an insured user, or customer of an insurance company, may submit claims in accordance with an insurance policy. This claims data may be aggregated by an insurance company and may be analyzed to create a claims data index. In another example, user-submitted data may include user demographics data including state or regional data. Such data may be automatically gathered, such as via a mobile application on a user's mobile device. Additionally or alternatively, a user may submit such information via a questionnaire on the user's mobile device. In some embodiments, this data may be analyzed in combination and a risk may then be associated with a certain demographic, as reflected by the value of an ETN. For example, a certain risk may be associated with a key demographic based at least in part upon insurance claims data submitted by one or more insurance customers belonging to the key demographic. Other indexes may be tracked as well with respect to the ETN, such as accident statistics in a specific state or region. For example, accident statistics published by a region's department of transportation (DOT) may provide an indicator of how safe a population is behind the wheel within that DOT's region. In some embodiments, an ETN price is in direct correlation with the indexes being tracked. For example, the ETN price may increase or decrease if at least one of the tracked indexes changes, such as if the accident statistics indicate an increase in accidents, the ETN price may increase accordingly. Vice versa, if the accident statistics indicate a decrease in the number of accidents within a certain region and over a certain period of time, the ETN price may decrease accordingly. It is understood that other types of indexes may be tracked and the examples set forth herein are merely presented for illustrative purposes.

External indexes may be tracked by an ETN with respect to publicly available data and information. For example, an external index may include stock market information or inflation information. An ETN based at least in part upon this external index may provide an indicator of the health of an economy. The price fluctuation of the ETN based at least in part upon the stock market or inflation data may accurately reflect the fluctuation in either the stock market or inflation data. Taken in combination, a price for the ETN may be determined 504 based at least in part upon multiple indexes, such as internal and external indexes. This ETN price may be an accurate guide for calculating a price of an insurance premium.

Method 500 may further include determining 512 a change in share price of an ETN based at least in part upon a performance of the plurality of underlying indexes. Positive performance of underlying indexes may cause the ETN share price to increase. If the underlying indexes experience stagnation, then the share price will stay at roughly the same price. Additionally, if one or more of the underlying indexes perform negatively, then the ETN share price may decrease accordingly. Method 500 may further include storing 514 data, including performance data, related to the ETN in an accessible location, such as database 404 of FIG. 4 or database 104 of Figure, for example.

Method 500 may include determining 516 a price of an insurance premium based at least in part upon the determined ETN price. In some embodiments, the price of the insurance premium may fluctuate over time in response to a fluctuation of an ETN price described herein and above. Based at least in part upon the performance, along with other possible factors, an insurance premium for a specific user may adjust over time. Method 500 may further include updating the stored ETN data in response to a change of an underlying indexes' performance. An ETN may be region-specific. In some embodiments, a certain ETN may only be applicable to insurance customers within a certain geographical region. For example, a user's location or demographic information may change over time, causing the index from which their insurance premium is derived to change. In this non-limiting example, the ETN associated with an insurance premium may change in response to a change in the user's location (e.g., the user moves cross-country), a change in the user's demographics (e.g., career change, marital status change, or the like), or a combination thereof. Other underlying indexes of an ETN may go through changes as well. In another embodiment, as traffic data changes or weather patterns change, underlying indexes may adjust as well, causing a change in a user's calculated insurance premium. For example, if an ETN tracks traffic data within a certain region or city, a series of different variables may be taken into consideration. These variables may include, but are not limited to, congestion levels, road construction zones, or the like. In yet another example, an ETN may be created to track weather patterns within a certain geographical region. Weather patterns may include rainfall, air pressure, temperature, or the like. The tracked weather patterns may be analyzed in view of key thresholds, such as historical weather pattern data (e.g., normal temperatures, normal rainfall amounts, or the like). Method 500 may further include updating 518 stored ETN data in response to change of index performance.

Certain methods may further include issuing of dividends based at least in part upon performance of the one or more underlying indexes. Based at least in part upon a contract, or smart contract, between an exchange or a financial institution, a dividend may be paid out between a backer of the ETN, such as a bank, and an investor, or owner of an ETN share. In at least one illustrative example, a smart contract may be made between an investor and a financial backer of the ETN. The smart contract may be written in code and stored on, or within, a blockchain, such as the Ethereum® blockchain. In some embodiments, the smart contract may be based at least in part upon the Ethereum Virtual Machine (EVM). The smart contract may include a number of conditions to make up the contract between the investor and the financial backer of the ETN. Included, for example, may be one or more events within the contract regarding a performance of the ETN. In an example of embodiment, for example, a dividend may be paid out to the investor when the ETN's price reaches a certain target price. The smart contract may execute code automatically in response to the ETN's price reaching an agreed upon target price, thereby causing the event of an expected dividend payout to be performed. For example, an ETN share's initial price may be $4.00, with a target price a $5.00, and a dividend payout may be $0.50. In this example, once the share's price reaches the target price of $5.00, code may be executed to cause the dividend payout amount of $0.50. In this non-limiting example, the steps set forth may be automated. In some embodiments, details, or conditions, of a smart contract may be made publicly available. On a platform utilizing a distributed ledger, such as an Ethereum® blockchain, smart contracts may be publicly viewable. Additionally, or alternatively, a dividend payout may be made automatically based at least in part upon a certain schedule set forth by and outlined by code within a smart contract.

Examples of Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based at least in part upon example inputs in order to make valid and reliable predictions for novel inputs.

Additionally or alternatively, the machine learning programs may be trained by inputting sample data sets or certain data into the programs, such as images, object statistics and information, audio and/or video records, text, and/or actual true or false values. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning or artificial intelligence.

In supervised machine learning, a processing element may be provided with example inputs and their associated outputs, and may seek to discover a general rule that maps inputs to outputs, so that when subsequent novel inputs are provided the processing element may, based at least in part upon the discovered rule, accurately predict the correct output. In unsupervised machine learning, the processing element may be needed to find its own structure in unlabeled example inputs.

As described above, the systems and methods described herein may use machine learning, for example, for pattern recognition. That is, machine learning algorithms may be used by ETNT computing device 102, for example, to identify patterns in internal index data and external index data for the pricing of ETNs and the pricing of insurance premiums based at least in part upon the pricing of the ETNs. Accordingly, the systems and methods described herein may use machine learning algorithms for both pattern recognition and predictive modeling.

### EXAMPLES OF EMBODIMENTS

In one aspect, an exchange-traded note (ETN) computing device having at least one processor in communication with a memory device is provided. The at least one processor may be configured to: (1) generate, by the ETN computing device, at least one ETN having a plurality of ETN shares, (2) issue, by the ETN computing device, the plurality of ETN shares, each ETN share having an initial share price, (3) receive, from at least one investor computing device, buy orders to buy one or more of the plurality of ETN sharesETN shares, (4) track, by the ETN computing device, a plurality of indexes, wherein index data associated with the plurality of indexes is obtained from one or more index computing devices (5) determine, by the ETN computing device, a change in the ETN share price shares based at least in part upon the index data, (6) store ETN data associated with the at least one ETN on the memory device, wherein the memory device is part of an implemented blockchain architecture, (7) determine an insurance premium cost based at least in part upon the ETN share price, and (8) update the stored ETN data in response to a change of one or more of the plurality of indexes.

A further enhancement of the ETN computing device may include wherein the plurality of indexes includes one or more external indexes and the at least one processor is further configured to track the one or more external indexes by tracking one or more public data sources including one or more weather data sources, traffic data sources, inflation data sources, or market data sources.

A further enhancement of the ETN computing device may include wherein the plurality of indexes includes one or more internal indexes and the at least one processor is further configured to track the one or more internal indexes by tracking one or more private data sources including one or more customer data sources, insurance claims data sources, or demographics data sources.

A further enhancement of the ETN computing device may include wherein the at least one processor is further configured to sell one or more ETN shares in response to the one or more buy orders and issue a dividend to the one or more investors based at least in part upon an agreement with the one or more investors.

A further enhancement of the ETN computing device may include wherein the at least one processor is further configured to adjust the ETN share price shares in response to a fluctuation in the one or more tracked indexes.

A further enhancement of the ETN computing device may include wherein the at least one processor is further configured to adjust the cost of the insurance premium in response to the adjustment of the ETN share price.

A further enhancement of the ETN computing device may include wherein ownership of the one or more shares is implemented on a blockchain.

The computing device may include additional, less, or alternate actions, including those discussed elsewhere herein.

In another aspect, a computer-based method may include (1) generating at least one ETN having a plurality of ETN shares, (2) issuing the plurality of ETN shares, each ETN share having an initial share price, (3) receiving buy orders to buy one or more of the plurality of ETN sharesETN shares, (4) tracking a plurality of indexes, wherein index data associated with the plurality of indexes is obtained from one or more index computing devices, (5) determining a change in the ETN share price shares based at least in part upon the index data, (6) storing ETN data associated with the at least one ETN on the memory device, wherein the memory device is part of an implemented blockchain architecture, (7) determining an insurance premium cost based at least in part upon the ETN share price, and (8) updating the stored ETN data in response to a change of one or more of the plurality of indexes.

A further enhancement of the computer-based method may include wherein the plurality of indexes include one of external indexes and internal indexes.

A further enhancement of the computer-based method may include wherein the internal indexes include one or more of claims data, demographics data, and regional data.

A further enhancement of the computer-based method may include wherein the external indexes include one or more weather data, stock market data, inflation data, and department of transportation (DOT) data.

A further enhancement of the computer-based method may include wherein determining the share price of the exchange-traded note includes (1) judging a performance of the plurality of indexes, (2) calculating the performance of the plurality of indexes based at least in part upon one or more of associated risk and historical data, and (3) outputting the ETN share price based at least in part upon the calculated performance.

A further enhancement of the computer-based method may include (1) receiving, from one or more investor computing devices, one or more buy orders to buy one or more ETN shares, (2) selling one or more ETN shares on an ETN exchange in response to the one or more buy orders, and (3) distributing a dividend to one or more investors based at least in part upon an agreement made with the one or more investor computing devices and in response to performance of the one or more tracked indexes.

A further enhancement of the computer-based method may include wherein the ETN is backed by one or more banks and financial institutions.

The computer-based method may include additional, less, or alternate actions, including those discussed elsewhere herein.

In yet another aspect, at least one non-transitory computer-readable storage media having computer-executable instructions embodied thereon may be provided that, when executed by at least one processor, the computer-executable instructions cause the processor to: (1) generate at least one ETN having a plurality of ETN shares, (2) issue the plurality of ETN shares, each ETN share having an initial share price, (3) receive buy orders to buy one or more of the plurality of ETN sharesETN shares, (4) track a plurality of indexes, wherein index data associated with the plurality of indexes is obtained from one or more index computing devices, (5) determine a change in the ETN share price shares based at least in part upon the index data, (6) store ETN data associated with the at least one ETN on the memory device, wherein the memory device is part of an implemented blockchain architecture, (7) determine an insurance premium cost based at least in part upon the ETN share price, and (8) update the stored ETN data in response to a change of one or more of the plurality of indexes.

A further enhancement of the computer-executable instructions may further cause the at least one processor to determine a change in the ETN share price based at least in part upon subsequent performance of the plurality of indexes.

A further enhancement of the computer-executable instructions may further cause the at least one processor to adjust the price of the insurance premium cost based at least in part upon the change in the ETN share price.

A further enhancement of the computer-executable instructions may further cause the at least one processor to receive one or more buy orders for the one or more ETN shares on an exchange.

A further enhancement of the computer-executable instructions may further include wherein the one or more internal indexes include indexes of insurance claims data or demographics data.

A further enhancement of the computer-executable instructions may further include wherein the one or more external indexes include indexes of stock market data, inflation data, weather data, or department of traffic data.

The computer-executable instructions may include additional, less, or alternate actions, including those discussed elsewhere herein.

### Examples of Additional Considerations

As will be appreciated based at least in part upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example of embodiment, the system is executed on a single computer system, without needing a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

1. An exchange-traded note (ETN) computing device comprising at least one processor in communication with a memory device, the at least one processor configured to:
generate at least one ETN having a plurality of ETN shares;
issue the plurality of ETN shares, each ETN share having an initial share price;
receive, from one or more investor computing devices associated to one or more investors, one or more buy orders to buy one or more of the plurality of ETN shares;
securely track a plurality of indexes corresponding to index data obtained from one or more index data sources using a blockchain architecture, the one or more index data sources being stored in one of a plurality of nodes in the blockchain architecture, the plurality of indexes comprising an internal index and an external index, the one or more index data sources comprising at least a private data source associated with the internal index and a public data source associated with the external index, the private data source comprising at least one selected from a group consisting of customer data sources, insurance claims data sources, and demographics data sources, the public data source comprising at least one selected from a group consisting of a traffic data source and a weather data source;
determine a change in ETN share price of the plurality of ETN shares based at least in part upon the index data;
store ETN data associated with the at least one ETN on the memory device, the memory device being part of the blockchain architecture;
access a trained predictive model for vehicle insurance premiums corresponding to the plurality of indexes, wherein the trained predictive model includes a machine learning model trained by historical index data;
determine a vehicle insurance premium cost based at least in part upon the ETN share price by at least:
applying the trained predictive model to the index data;
identifying one or more patterns in the index data; and
determining the vehicle insurance premium cost using the trained predictive model and based at least in part upon the ETN share price and the one or more identified patterns; and
update the stored ETN data in response to a change of one or more of the plurality of indexes.

2. The ETN computing device of claim 1, wherein the:
public data source further includes at least one selected from a group consisting of inflation data sources and market data sources.

3. (canceled)

4. The ETN computing device of claim 1, wherein the at least one processor is further configured to:
sell the one or more of the plurality of ETN shares in response to the one or more buy orders; and
issue a dividend to each investor computing device of the one or more investor computing devices based at least in part upon an agreement with the one or more investors.

5. The ETN computing device of claim 1, wherein the at least one processor is further configured to:
adjust the share price of the plurality of ETN shares in response to a fluctuation in the one or more of the plurality of indexes.

6. The ETN computing device of claim 5, wherein the at least one processor is further configured to:
adjust the cost of the insurance premium in response to the adjustment of the share price.

7. The ETN computing device of claim 1, wherein ownership of the one or more shares is implemented on the blockchain architecture.

8. A computer-implemented method for calculating an insurance premium by a computing device including one processor in communication with a memory device, the method comprising:
generating, by an exchange-trade note (“ETN”) computing device, at least one ETN having a plurality of ETN shares;
issuing, by the ETN computing device, the plurality of ETN shares, each ETN share having an initial share price;
receiving, from one or more investor computing devices associated with one or more investors, one or more buy orders to buy one or more of the plurality of ETN shares;
securely tracking, by the ETN computing device, a plurality of indexes corresponding to index data obtained from one or more index data sources using a blockchain architecture, the one or more index data sources being stored in a plurality of nodes in the blockchain architecture, the plurality of indexes comprising an internal index and an external index, the one or more index data sources comprising at least a private data source associated with the internal index and a public data source associated with the external index, the private data source comprising at least one selected from a group consisting of customer data sources, insurance claims data sources, and demographics data sources, the public data source comprising at least one selected from a group consisting of a traffic data source and a weather data source;
determining, by the ETN computing device, a change in ETN share price of the plurality of ETN shares based at least in part upon the index data;
storing ETN data associated with the at least one ETN on the memory device, the memory device being part of the blockchain architecture;
accessing a trained predictive model for vehicle insurance premiums corresponding to the plurality of indexes, wherein the trained predictive model includes a machine learning model trained by historical index data;
determining a vehicle insurance premium cost based at least in part upon the ETN share price by at least:
applying the trained predictive model to the index data;
identifying one or more patterns in the index data; and
determining the vehicle insurance premium cost using the trained predictive model and based at least in part upon the ETN share price and the one or more identified patterns; and
updating the stored ETN data in response to a change of one or more of the plurality of indexes.

9. (canceled)

10. The computer-implemented method of claim 8, wherein the internal index includes one or more of claims data, demographics data, and regional data.

11. The computer-implemented method of claim 8, wherein the external index include at least one index of at least one selected from a group consisting of weather data, stock market data, inflation data, and department of transportation (DOT) data.

12. The computer-implemented method of claim 8, wherein determining the share price change of the exchange-traded note includes:
judging a performance of the plurality of indexes;
calculating the performance of the plurality of indexes based at least in part upon one or more of associated risk and historical data; and
outputting the ETN share price based at least in part upon the calculated performance.

13. The computer-implemented method of claim 8, further comprising:
selling one or more ETN shares on an ETN exchange in response to the one or more buy orders; and
distributing a dividend to the one or more investors based at least in part upon an agreement made with the one or more investors and in response to the performance of the one or more indexes.

14. The computer-implemented method of claim 8, wherein the ETN is backed by one or more banks and financial institutions.

15. At least one non-transitory computer-readable media having computer-executable instructions embodied thereon, wherein when executed by an exchange-traded note tracking (ETNT) computing device including one processor in communication with a memory device, the computer-executable instructions cause the at least one processor to:
generate at least one ETN having a plurality of ETN shares;
issue the plurality of ETN shares, each ETN share having an initial share price;
receive one or more buy orders to buy one or more of the plurality of ETN shares;
securely track a plurality of indexes, index data associated with the plurality of indexes being obtained from one or more index data sources using a blockchain architecture, the one or more index data sources being stored in a plurality of nodes in the blockchain architecture, the plurality of indexes comprising an internal index and an external index, the one or more index data sources comprising at least a private data source associated with the internal index and a public data source associated with the external index, the private data source comprising at least one selected from a group consisting of customer data sources, insurance claims data sources, and demographics data sources, the public data source comprising at least one selected from a group consisting of a traffic data source and a weather data source;
determine a change in the ETN share price of the plurality of ETN shares based at least in part upon the index data;
store ETN data associated with the at least one ETN on the memory device, the memory device being part of the blockchain architecture;
access a trained predictive model for vehicle insurance premiums corresponding to the plurality of indexes, wherein the trained predictive model includes a machine learning model trained by historical index data;
determine a vehicle insurance premium cost based at least in part upon the ETN share price by at least:
applying the trained predictive model to the index data;
identifying one or more patterns in the index data; and
determining the vehicle insurance premium cost using the trained predictive model and based at least in part upon the ETN share price and the one or more identified patterns; and
update the stored ETN data in response to a change of one or more of the plurality of indexes.

16. The at least one non-transitory computer-readable media of claim 15, the computer-executable instructions further cause the at least one processor to:
determine a change in the ETN share price based at least in part upon subsequent performance of the plurality of indexes.

17. The at least one non-transitory computer-readable media of claim 16, the computer-executable instructions cause the at least one processor to:
adjust the price of the insurance premium cost based at least in part upon the change in the ETN share price.

18. The at least one non-transitory computer-readable media of claim 15, wherein the computer-executable instructions further cause the at least one processor to:
receive one or more buy orders for the one or more ETN shares on an exchange.

19. The at least one non-transitory computer-readable media of claim 15, wherein the internal index includes indexes of insurance claims data or demographics data.

20. The at least one non-transitory computer-readable media of claim 15, wherein the external index include at least one index of at least one selected from a group consisting of stock market data, inflation data, weather data, and department of traffic data.

21. An exchange-traded note (ETN) system comprising:
a blockchain architecture comprising a plurality of nodes, each node of the plurality of nodes including a memory device; and
an ETN computing device coupled to the blockchain architecture and configured to:
generate at least one ETN having a plurality of ETN shares;
issue the plurality of ETN shares, each ETN share having an initial share price;
receive, from one or more investor computing devices associated to one or more investors, one or more buy orders to buy one or more of the plurality of ETN shares;
securely track a plurality of indexes corresponding to index data obtained from one or more index data sources using the blockchain architecture, the one or more index data sources being stored in the plurality of nodes of the blockchain architecture, the plurality of indexes comprising an internal index and an external index, the one or more index data sources comprising at least a private data source associated with the internal index and a public data source associated with the external index, the private data source comprising at least one selected from a group consisting of customer data sources, insurance claims data sources, and demographics data sources, the public data source comprising at least one selected from a group consisting of a traffic data source and a weather data source;
determine a change in ETN share price of the plurality of ETN shares based at least in part upon the index data;
store ETN data associated with the at least one ETN on at least one of the plurality of nodes in the blockchain architecture;
access a trained predictive model for vehicle insurance premiums corresponding to the plurality of indexes, wherein the trained predictive model includes a machine learning model trained by historical index data;
determine a vehicle insurance premium cost based at least in part upon the ETN share price by at least:
applying the trained predictive model to the index data;
identifying one or more patterns in the index data; and
determining the vehicle insurance premium cost using the trained predictive model and based at least in part upon the ETN share price and the one or more identified patterns; and
update the stored ETN data in the at least one of the plurality of nodes in the blockchain architecture in response to a change of one or more of the plurality of indexes.
